(19) United States
(12) Patent Application Publication
(10) Pub. No.: US 2012/0243279 A1
(43) Pub. Date: Sep. 27, 2012

(54) Buck Converter and Inverter Comprising the same

(75) Inventors: Peter Zacharias, Kassel (DE); Benjamin Sahan, Kassel (DE); Samuel Vasconcelos Araujo, Kassel (DE); Mehmed Kanzanbas, Kassel (DE); Andreas Falk, Kassel (DE)

(73) Assignee: SMA Solar Technology AG, Niestetal (DE)

(21) Appl. No.: 13/467,382

(22) Filed: May 9, 2012

Related U.S. Application Data
(63) Continuation of application No. PCT/EP2010/067078, filed on Nov. 9, 2010.

(30) Foreign Application Priority Data
Nov. 9, 2009 (DE) 102009052461.4

(51) Int. Cl. H02M 7/537; G05F 3/08

(52) U.S. Cl. 363/131; 323/311

(57) ABSTRACT

A buck converter for converting a DC voltage at input terminals into an output voltage at output terminals is disclosed. The buck converter includes a DC voltage link including a series-connection of at least two capacitors between the output terminals, and one subcircuit per each capacitor of the series-connection. Each subcircuit includes an inductor and a freewheeling diode. A first one of the input terminals is connected to a first output terminal by a series-connection of a semiconductor switch and the inductor of a first one of the subcircuits, and the subcircuits are coupled for balancing the voltages across their inductors. The buck converter may be used upstream of an inverter bridge of an inverter, such that a maximum voltage at the input terminals may exceed a maximum voltage rating of the bridge switches within the inverter.

### CROSS REFERENCE TO RELATED APPLICATIONS

This application is a continuation of International Application No. PCT/EP2010/067078, filed on Nov. 9, 2010, which claims priority to co-pending German Patent Application No. DE 10 2009 052 461.4, entitled, “Wechselrichter-schaltungsanordnung”, filed Nov. 9, 2009.

### FIELD

The present invention generally relates to a buck converter with coupled subcircuits. In particular the present invention relates to a buck converter forming an input part of an inverter that includes input terminals for connecting a photovoltaic generator, an AC output, and a bridge circuit comprising semiconductor switching elements for DC-AC conversion.

### BACKGROUND

Photovoltaic inverters are used to convert the DC voltage generated by photovoltaic generators or modules into grid-compliant power. Inverters of this type need to have a comparatively high rate of efficiency. For this reason, efforts are being made to lower the switching losses and other kinds of losses coming from the inverter or from the photovoltaic power system.

Known photovoltaic inverters have an input voltage or system voltage of up to 1000 V. Standard semiconductor components with a maximum voltage rating of 1200 V are used in such inverters.

Photovoltaic inverters that have a lower input voltage also exist. In this case, step-up converters are used to increase the DC voltage while the inverter or, more specifically, the inverter bridge or bridge circuit of the inverter is usually stepping down the voltage to the level of the grid voltage.

Some solutions are known to contain a DC/AC converter and a power transformer, which means they do not require a step-up converter for voltage adjustment. The inclusion of a power transformer, however, entails additional losses.

Losses can be reduced by increasing the system or open-circuit DC voltage of a photovoltaic inverter to 1500 V, for example. There are several reasons for this.

An increase in photovoltaic voltage may obviate the need for a step-up converter in transformerless power systems and thus increase the efficiency.

In devices featuring a power transformer, the voltage applied to the primary side of the transformer could be increased, which in turn would lower the corresponding current and therefore reduce any conduction losses.

A higher voltage and hence a lower current would be advantageous insofar as it would lead to lower ohmic losses in all supply lines, contacts or similar components.

Increasing the input DC voltage, however, has a significant disadvantage in that the voltage load of standard 1200 V semiconductors would be exceeded so that expensive and higher-loss 1700 V semiconductors may be required. Increasing the voltage to 1500 V would furthermore limit the available inverter operation range when using 1700 V semiconductors, thereby compromising on cost efficiency.

In order to operate a photovoltaic inverter with an input voltage of 330 V to 1000 V, a buck converter such as the one disclosed in DE 10 2005 047 373 A1 may be used. This buck converter consists of two switches, two series capacitors, two freewheeling diodes and two storage chokes. Note, however, that this converter is only designed for voltages of 1200 V or less. It is not designed for higher voltages of 1500 V, for example. It also requires two semiconductor switches that are located entirely within the current path, which is expensive due to the greater number of components involved and hence entails additional losses.

According to DE 101 03 633 A1, a power electronic choke converter with multiple subcircuits can be used to adjust the voltage. Such a converter requires three switches, three freewheeling diodes, three storage chokes and two capacitors.

U.S. Pat. No. 5,977,753 A discloses a buck converter providing two outputs via two transformer-coupled inductors. Each inductor is connected to a respective output capacitor and to a respective diode for allowing current to flow in the respective inductor for charging the respective output capacitor during intervals between pulses of a pulsed input supply. The input supply is provided by a switch arranged in an input supply line. One inductor is directly connected downstream to the switch and the other inductor is connected via a coupling capacitor to the switch so that the current for charging the respective output capacitors flow in both inductors during the pulses. The output voltages at the two outputs can be different.

### SUMMARY

In one embodiment of the present invention a buck converter is provided that requires a low number of active components and have a high efficiency.

In another embodiment of the present invention a buck converter is provided that keeps the DC input link voltage of an inverter constant so as to allow the use of 1200 V rated semiconductors. A constant DC input link voltage furthermore reduces semiconductor conduction losses and magnetization losses.

The present invention relates to a buck converter for converting a DC voltage at input terminals into an output voltage at output terminals. This buck converter comprises a DC link comprising a series-connection of at least two capacitors between the output terminals; and one subcircuit per each capacitor of the series-connection, each subcircuit including an inductor and a freewheeling diode. A first one of the input terminals is connected to a first output terminal by a series-connection of a semiconductor switch and the inductor of a first one of the subcircuits; and the subcircuits are coupled for balancing the voltages across their inductors.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a depiction of a PV plant with an inverter system or, more specifically, a grid-connected PV plant comprising an inverter with a buck converter, which is arranged at its input, and with a DC switch.

FIG. 2 shows a first embodiment of the buck converter.

FIG. 3 shows a second embodiment of the buck converter.

FIG. 4 indicates the current flow paths in the buck converter when the semiconductor switch is closed.

FIG. 5 indicates the current flow paths in the buck converter when the semiconductor switch is open.

FIG. 6 is a diagram of the currents flowing in the buck converter.

FIG. 7 is a diagram of normalized voltages blocked by a semiconductor switch of the buck converter.

FIG. 8 is a diagram of normalized switching losses in the semiconductor switch.

FIG. 9 is another diagram of normalized conduction losses; and

FIG. 10 shows a circuit configuration according to the prior art.

### DETAILED DESCRIPTION

The invention involves the idea of using a buck converter as an input stage of a photovoltaic inverter with a DC voltage link. The buck converter has a remarkably high rate of efficiency, which is advantageous due to its preceding position in the current path.

The invention makes use of the knowledge that a buck converter represents a very efficient solution in comparison to all other power electronic converters. The particular buck converter of the invention may be designed to reduce the maximum voltage present at the semiconductor components so as to allow the use of components with low specific switching losses and costs. Specific switching losses depend on the maximum reverse voltage and, when using 3rd generation IGBTs, for example, can be approximated by the following equation:

P_{S}=(U_{S,max}/U_{ref})^{1.4}

For a conventional buck converter, which is designed for the entire operation voltage range, the voltage transformation ratio M equals the duty cycle D (M=D, wherein 0≦M≦1). The maximum switch voltage U_{S,max} related to the input voltage U (or E1 or U1) yields U_{S,max}/U₁=1, and related to the output voltage U₂ yields U_{S,max}/U₂=1/M.

The goal of this invention is to design a buck converter that can take advantage of the following: In practice, the actual voltage range of a PV generator is less than 1:2. Given a constant output voltage, the reverse voltage U_{S,max} should result from the difference between the input and half the output voltage

$${U}_{S , ma x} = {U}_{1} - ( {U}_{2} / 2 ) = {U}_{2} \cdot ( \frac{1}{M} - \frac{1}{2} ) = {U}_{1} \cdot ( 1 - \frac{M}{2} ) .$$

However, the full output voltage U₂ should be present before the switch is actuated, which can be achieved by controlling the inverter appropriately.

The invention ensures that the inverter covers a specific input voltage range. Photovoltaic power systems have a designated maximum system voltage that may not be exceeded. When feeding power into a public 400 V grid, the maximum power point (MPP) for a three-phase inverter must be higher than 700 V. With regard to the operation voltage range, however, photovoltaic generators can produce very high open circuit voltages.

One basic idea of the invention involves dividing the DC voltage link into at least two capacitors and equipping each capacitor with a corresponding choke or inductor, and a freewheeling path.

The invention makes it possible to increase the system voltage to 1500 V in a highly efficient manner.

According to an aspect of the invention, the buck converter may be connected upstream of an inverter bridge circuit of a photovoltaic inverter. The buck converter comprises a semiconductor switch being serial-connected to a first inductor and to at least two series capacitors forming a DC voltage link, wherein, at a midpoint of the series capacitors, a freewheeling diode and an additional inductor are connected. The additional inductor drives a freewheeling current through an additional diode, when the semiconductor switch is open. This solution has the advantage of requiring only a single switch with a comparably low voltage rating and hence a high efficiency. A cost-effective standard 1200 V semiconductor switch, for example, can be used for a system voltage of 1500 V.

Another advantage that this invention has over conventional circuits is that the maximum voltage present at the switch of the buck converter is less than the input voltage. In conventional buck converters it is equal to the input voltage.

The invention easily achieves the goal to limit the input voltage to the inverter bridge of the inverter to 1000 V or less. The permissible voltage load on the semiconductor components may be in a range from a third to three quarters of the input voltage provided by the generator. In one embodiment it is in a range from 900 V to 1300 V, particularly about 1000 V. The maximum input voltage of the buck converter may be substantially higher than 1000 V, particularly higher than 1200 V. It may be in a range from 1300 V to 1700 V, particularly about 1500 V. The output voltage of a photovoltaic generator connected to the input of the buck converter may, for example, be in a range from 1000V to 1500 V. The voltage load on the semiconductor switch of the buck converter may be in a range from a quarter to a half of the input voltage provided by the generator. In one embodiment it is in a range from 800 V to 1000 V, particularly about 900 V.

When designing the circuitry, it must be ensured that the full output voltage is present before the switch of the buck converter is actuated, which can be achieved by controlling the inverter accordingly.

In one advantageous embodiment of the buck converter of this invention, a coupling capacitor is connected between a junction point of the semiconductor switch and the first inductor and a junction point of the additional inductor and the additional diode. The purpose of the coupling capacitor is to demagnetize leakage inductance when using a magnetic-coupled choke with a leakage-prone coupling and to prevent the complete demagnetization of the second inductor. Coils can be used to form the inductors. The coupling capacitor also serves as an additional coupling means between the different inductor coils since the coils are arranged in parallel to this capacitor during each switching process, thereby balancing the voltages across the inductor coils. As a result, changing the turns ratio N1/N2 of the inductors has no effect on the voltage split between the series capacitors.

With the coupling capacitor, the inductances can even be provided by magnetically-uncoupled chokes. This is one embodiment of the invention.

As the coupling capacitor can be used to neutralize the magnetic coupling between the two coils, the inductances can also be implemented as air coils in order to achieve a simplified circuit. Another advantage of air coils is that they allow for a higher current ripple without any noticeable drop in efficiency.

In another embodiment of the circuit configuration based on this invention, the coupling capacitor has the same capacitance as the second series capacitor connected to the additional diode. The voltage ripple therefore has the same value on both the coupling capacitor and the second capacitor, which results in the simultaneous blocking of both freewheeling diodes.

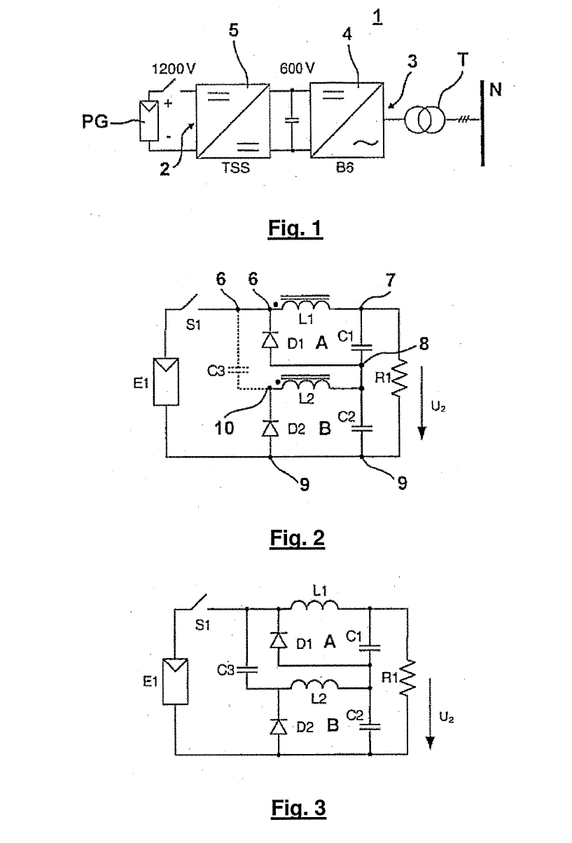

Referring now in greater detail to the drawings, FIG. 1 shows a circuit configuration of an inverter 1 with a DC voltage input 2 including a DC switch for connecting a photovoltaic generator PG, and an AC voltage output 3, which is connected to an AC power grid N via a transformer T. An embodiment of the inverter 1 without a transformer is also possible. The inverter 1 is used to convert a DC voltage of, for example, 1100 V, wherein the maximum system voltage or open circuit voltage of the photovoltaic generator PG is 1500 V DC, into a three-phase AC voltage of 220/380 V, 50 Hz, for example. The maximum operating voltage may, for example, range from 1100 V to 1200 V and is dependent on the wiring and type of photovoltaic modules of the photovoltaic generator PG. The inverter 1 includes an inverter bridge or bridge circuit composed of semiconductor elements in a full-bridge or half-bridge configuration, like, e.g., in a B6 circuit that forms a DC/AC converter 4.

The bridge circuit is located downstream from a buck converter 5 which is connected to the generator voltage on its input side and which is connected to the bridge circuit on its output side. This means that the buck converter is placed at an input side of the bridge circuit. The buck converter and the bridge circuit are two separate units. The step-down ratio of the buck converter is configured so that its permissible input voltage exceeds the maximum voltage rating of the semiconductor switching elements in the bridge circuit while its output voltage is reduced so that the voltage rating of the semiconductor switching elements is not exceeded. The buck converter 5 reduces the inverter voltage load or, more specifically, the voltage load of the semiconductors. The voltage rating of the semiconductor switching elements is 1200 V, for example, depending on the circuit configuration. In order to use 1200 V IGBTs or other components, the maximum switch voltage, continuous voltage, or maximum operating voltage must be lower than 1000 V. The bridge circuit includes IGBTs or MOSFETs or a combination thereof.

The DC/AC converter 4 is placed downstream from the buck converter 5, which reduces the input voltage of 1200 V (1500 V under open-circuit condition) by about 50 percent, e.g., to 600 V (see FIG. 1) according to the aforementioned equation U_{S,max}=U1−(U₂/2).

Here, the following is observed in one embodiment:
U₁ (E1) should be greater than the maximum grid voltage.
U₂ should be greater than the maximum grid voltage.
U₂ should be lower than the voltage rating of the semiconductor switching elements in the bridge.
U₁ (E1) should be lower than the maximum operating voltage or open circuit voltage.

FIG. 2 depicts an embodiment of the buck converter 5. The circuitry includes a semiconductor switch S1, which can either be an IGBT or a MOSFET with a voltage rating of 1200 V. A maximum switch voltage will only be present when the switch S1 is open.

The circuitry also has two choke coils as inductors L1 and L2, which are magnetically coupled here, two series capacitors C1 and C2, two freewheeling diodes D1 and D2, and a coupling capacitor C3. The load formed by the DC/AC converter 4 is represented by a resistor R1. There are five junction points referred to as 6 to 10. The first junction point 6 is located between the switch S1 and the inductor L1/coupling capacitor C3. The second junction point 7 is located between the inductor L1 and the first capacitor C1. The third junction point 8 is located between the two series capacitors/DC voltage link capacitors C1 and C2 and between the first diode D1 and the second inductor L2. The fourth junction point 9 is located between the second series capacitor C2 and the second diode D2. The fifth junction point 10 is located between the coupling capacitor C3 and the second inductor L2 or the second diode D2, respectively.

The first inductor L1, the first diode D1 and the first capacitor C1 form a first subcircuit A; and the second inductor L2, the second diode D2 and the second capacitor C2 form a second subcircuit B of the buck converter 5. As a result of this, an output DC voltage link of the buck converter is split over multiple subcircuits each including one of the series capacitors. In addition, two freewheeling paths are formed (L1, D1; L2, D2).

As shown in FIG. 2, the coupling capacitor C3 is connected between first junction point 6 and the fifth junction point 10. As indicated by a dotted line, the coupling capacitor C3 may also be excluded in this variant, in which the inductors L1 and L2 are magnetically coupled.

As an alternative to the circuit in FIG. 2, the inductors L1 and L2 can be formed as magnetically uncoupled chokes and may be implemented as air coils as shown in FIG. 3. In all other respects the circuit has the same configuration as the circuit shown in FIG. 2.

Ideally, the circuit would operate under continuous current conditions. Achieving this condition depends on whether enough energy storage is available, and not so much on the specific properties of the components used. As a boundary condition in a stationary mode, the voltages across all capacitors are equal to half the output voltage, wherein the capacitance of the capacitors C1 and C2 is assumed to be equal, thereby enabling the simultaneous blocking of diodes D1 and D2. It would be advantageous, however, if capacitor C1 had a much smaller capacitance than capacitor C2 due to its lower ripple compared to capacitor C2.

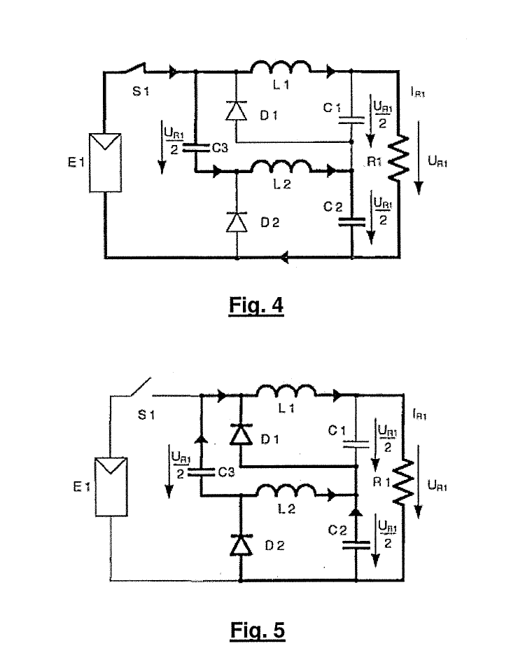

In a first step shown in FIG. 4, the switch S1 is closed. The photovoltaic input current is distributed between the two power circuits or subcircuits A and B. One portion of the current flows through the first coil or inductor L1 and the load (resistor R1), while the other flows through the coupling capacitor C3, the inductor L2 and the capacitor C2. During this process the diodes D1 and D2 are blocking, and energy is stored in the chokes or inductors L1 and L2 and the capacitors C2 and C3. The current flowing through capacitor C1 is negligible, but the capacitor C1 provides for a symmetric distribution of the output DC link voltage over the subcircuits A and B. The distribution of the current over the inductors L1 and L2 and over the capacitors C1, C2, C3, however, is asymmetrical as a result.

In a second step shown in FIG. 5, the switch S1 is open. The polarity of the voltage across both choke coils (inductors L1 and L2) changes, which causes the diodes D1 and D2 to switch. The load current I_{R1} is now distributed via the capacitor C2 and the diode D2. This causes the two chokes (inductors L1 and L2) and the capacitors C2 and C3 to discharge. A switch voltage not exceeding U₁−U_{R1}/2 and U₁−U_{C3} (U_{R1} being the output voltage across R1, and U_{C3} being the voltage across capacitor C3) is present at switch S1 at this moment (i.e., approx. 1200 V−300 V=900 V). This voltage is significantly lower than both the input voltage U₁ and the switch voltage rating of 1200 V.

The above steps also require that the capacitors C2 and C3 have the same capacitance. The voltage ripple on both capacitors therefore has the same value, which in turn causes the simultaneous blocking of the diodes D1 and D2.

FIG. 6 shows current waves in normal operation. If S1 is closed (V_{gate}S1=high), then I_{R1} is roughly equal to I_{L1}, and I_{C2} is roughly equal to I_{C3}. If switch S1 is open, then the current I_{D1} is roughly equal to I_{D2}, and the direction of the currents I_{C2} and I_{C3} is reversed. FIG. 6 also shows the currents I_{L2}, I_{S1} and I_{C1}.

The transformation ratio is determined by the time-integral of the choke voltage:

∫U_{L1}dt=(E1−U_{R1})·tₒₙ=(U_{R1}/2)·(T−tₒₙ)

From this equation, the following is derived for the voltage transformation ratio M:

D·(E1−U_{R1})=(U_{R1}/2)·(1−D)

U_{R1}/(E1−U_{R1})=(2·D)/(1−D)

M=U_{R1}/E1=(2·D)/(1+D)

wherein
E₁ or U₁ refers to the photovoltaic voltage or input voltage, and
D refers to the duty cycle.

Conversely, the following applies to the duty cycle D:

D=M/(2−M)

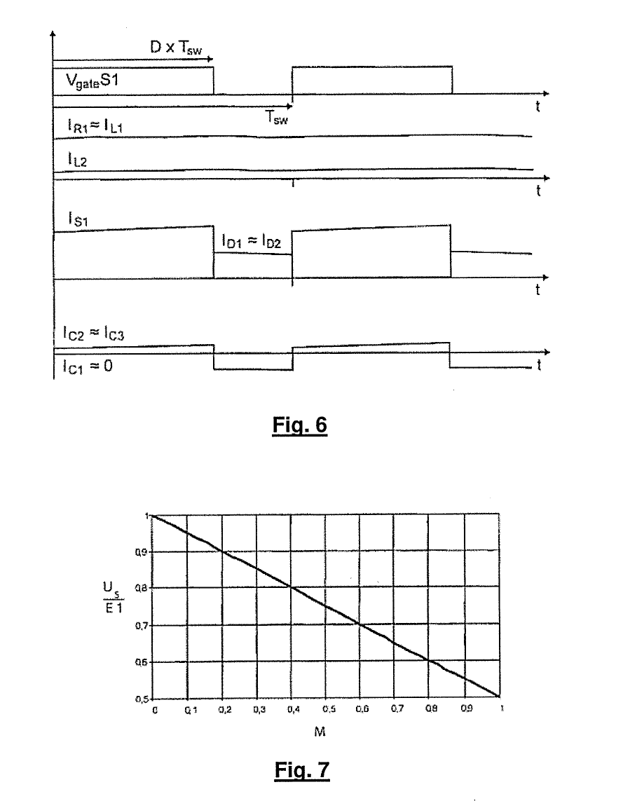

FIG. 7 shows the relative reverse voltage (U_{S,max}) or the normalized switch voltage of the switch S1 as a function of M.

The maximum and periodic switch voltage U_{S}, and the respective diode voltages U_{D1} and U_{D2} are

U_{S}=U_{D1}=U_{D2}=E1−(U_{R1}/2)=E1·(1−M/2)

and are therefore dependent on the voltage transformation M.

For this reason, the circuit configuration is only effective for applications in which the transformation ratio or input voltage is limited to a specific range, as it is the case with photovoltaic applications.

Now, semiconductor losses will be analyzed and then compared to a standard buck converter.

To analyze the switching losses in the topology, the amount of DC power that is released will be considered first.

P_{DC2}=I_{R1}·U_{R1}=I_{R1}·E1·M

Thus, the amount of DC power that is received is:

P_{DC1}=I_{S}·E1·D=I_{S}·E1·(M/(2−M))=P_{DC2}=I_{R1}·E1·M

The switching current Iₛ is therefore obtained as

I_{S}=I_{R1}·(2−M)

The switching losses are proportional to

P_{SW}=I_{S}·U_{S}·ε(U_{S,max})=[I_{R1}·(2−M)]·[E1·(1−(M/2))]·(1−(Mₘᵢₙ/2))

P_{SW}=I_{R1}·E1·[((2−M)2·(2−Mₘᵢₙ))/4]

This results in weighted switching losses normalized to the DC power of

πS=π_{S}_{_{—}}_{buck}=((2−M)2·(2−Mₘᵢₙ))/4M

Of particular interest in this analysis is the extent to which the switching losses in the proposed circuit are changed when compared to a conventional buck converter given the same transformation ratio. This leads to:

πS/π_{S}_{_{—}}_{buck}=((2−M)2·(2−Mₘᵢₙ))/4M

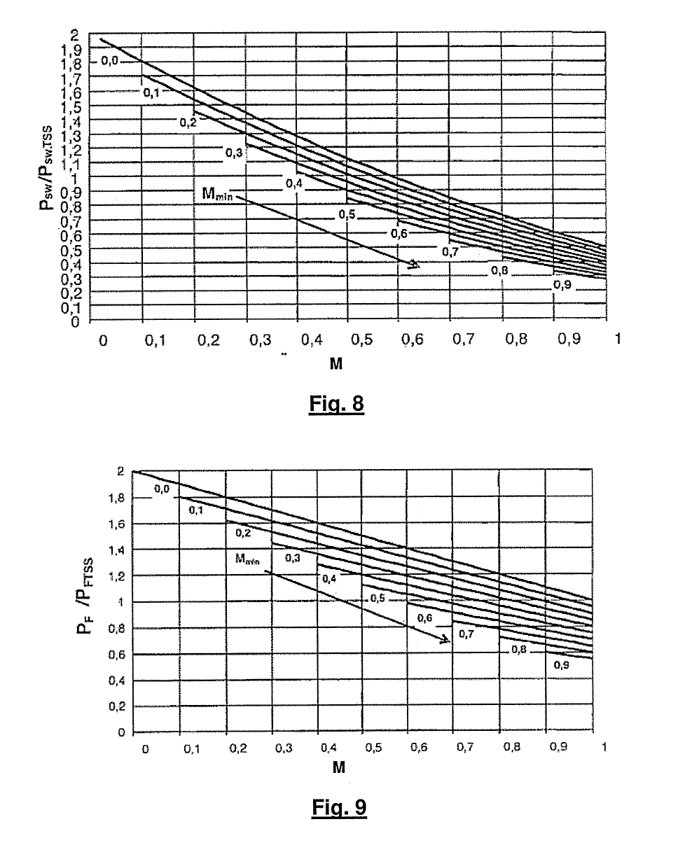

FIG. 8 shows the switching losses in normalized form based on the assumption that an operation range with a lower limit Mₘᵢₙ allows for the use of switches of lower voltage rating having lower specific switching losses.

The average of the squared current curve (Root Mean Square) is used to illustrate the conduction losses.

I²_{S,RMS}=I²_{S}·D=[I_{R1}·(2−M)]²·D

With reference to the DC current I_{R1}, the conduction losses of the switch S yield:

P_{F}/P_{F}(D=1;Mₘᵢₙ=0)=[RS·(IR1·(2−M))2/(I²_{R1}·R_{S})]*D·ε(Mₘᵢₙ)=(2−M)²·(M/(2−M))·(1−(Mₘᵢₙ/2))

P_{F}/P_{F}(D=1;Mₘᵢₙ=0)=M·(2−M)·((2−Mₘᵢₙ)/2)

One interesting aspect of this analysis involves drawing a comparison with a conventional buck converter. This can be described analytically based on a simple buck converter model:

P_{F}/P_{F}(D=1;Mₘᵢₙ=0)·(P_{F}(D=1;Mₘᵢₙ=0)/P_{F}_{_{—}}_{buck})=((2−Mₘᵢₙ)/2)·(2−M)

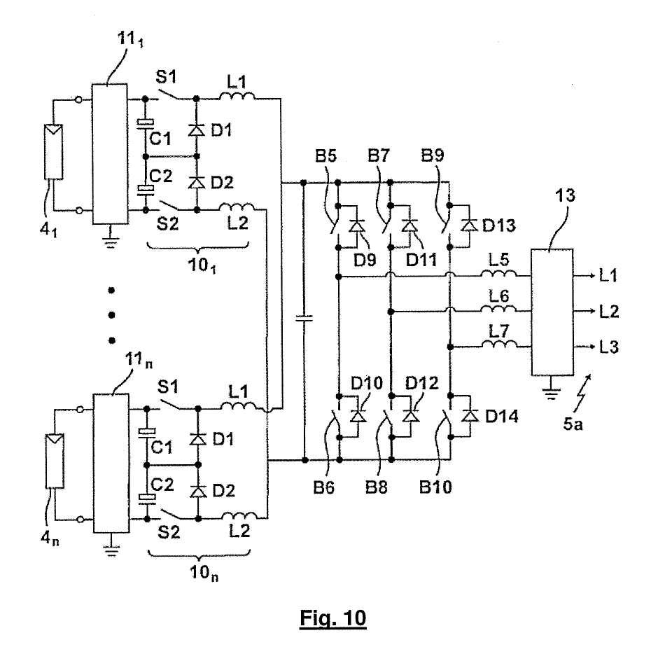

FIG. 9 shows the normalized conduction losses of the switch S1 as a function of the voltage transformation ratio M and the operation range lower limit Mₘᵢₙ.

Both graphics show that the proposed circuitry is characterized by minor switching and conduction losses, if the transformation ratio is limited, which is significantly more advantageous.

It can therefore be concluded that the circuit configuration based on this invention represents the most efficient solution with the lowest number of components.

It is important to note here that a system voltage of approx. 1500 V leads to the following voltages:

Maximum photovoltaic voltage (open circuit): 1500 V
Maximum operating voltage in MPP operation: 1200 V
Maximum switch voltage in MPP operation: approx. 600 V

Because the maximum switch voltage in MPP operation is 600 V only, semiconductors rated at 1200 V can be used instead of 1700 V rated semiconductors.

The operating voltage is relevant for selecting the appropriate voltage rating. The switch voltage should however not exceed around ⅔ of the maximum operating voltage due to the so-called “derating factor”, and due to cosmic radiation, respectively.

FIG. 10 shows a different solution based on prior art that requires a higher number of components (as documented in DE 10 2005 047 373 A1). When comparing the circuits based on FIG. 2 and FIG. 10, this advantage becomes especially apparent.

The invention is not limited to this example, which means the circuit may also have multiple switches S1 in series and/or freewheeling diodes in series to increase overall voltage stability. A separation into other subcircuits is also possible. Another possibility would involve segmented MPP control of a photovoltaic field through multiple parallel-connected input stages or the buck converter 5, respectively.

The DC/AC converter 4 of FIG. 1 may also be based on a configuration that includes a DC/DC stage and a DC/AC stage.

Many variations and modifications may be made to the preferred embodiments of the invention without departing substantially from the spirit and principles of the invention. All such modifications and variations are intended to be included herein within the scope of the present invention, as defined by the following claims.

1. A buck converter for converting a DC voltage at input terminals into an output voltage at output terminals, the buck converter comprising:
a DC voltage link comprising a series-connection of at least two capacitors between the output terminals; and
one subcircuit per each capacitor of the series-connection, wherein each subcircuit comprises an inductor and a freewheeling diode;
wherein a first one of the input terminals is connected to a first output terminal by a series-connection of a semiconductor switch and the inductor of a first one of the subcircuits, and wherein the subcircuits are configured to balance a voltage across their respective inductors with respect to one another.

2. The buck converter according to claim 1, wherein in each subcircuit its inductor, its capacitor and its freewheeling diode are connected together in a closed loop.

3. The buck converter according to claim 1, wherein the inductors of the subcircuits comprise magnetically coupled chokes.

4. The buck converter according to claim 1, wherein the inductors of the subcircuits are capacitively coupled at their input ends.

5. The buck converter according to claim 4, further comprising a coupling capacitor connected between a junction point of the semiconductor switch and the inductor of the first one of the subcircuits and a junction point of the inductor and the freewheeling diode of the second one of the subcircuits.

6. The buck converter according to claim 5, wherein the coupling capacitor has a capacitance substantially equal to the capacitance of the capacitor of the second one of the subcircuits.

7. The buck converter according to claim 4, wherein the inductors of the subcircuits comprise magnetically uncoupled inductors comprising air coils.

8. The buck converter according to claim 1, wherein a voltage rating of the semiconductor switch is between one-fourth and one-half of a maximum operation value of the DC voltage.

9. An inverter comprising a buck converter comprising:
a buck converter configured to convert a DC voltage at input terminals into an output voltage at output terminals, the buck converter comprising:
a DC voltage link comprising a series-connection of at least two capacitors between the output terminals; and
one subcircuit per each capacitor of the series-connection, wherein each subcircuit comprises an inductor and a freewheeling diode;
wherein a first one of the input terminals is connected to a first output terminal by a series-connection of a semiconductor switch and the inductor of a first one of the subcircuits, and wherein the subcircuits are configured to balance a voltage across their respective inductors with respect to one another; and
a DC/AC converter configured to receive a DC voltage at the output terminals of the buck converter and generate an AC voltage in response thereto.

10. The inverter according to claim 9, further comprising a transformer at an output of the DC/AC converter.

11. The inverter according to claim 9, wherein an AC output of the inverter is configured to be connected to an AC power grid.

12. The inverter according to claim 9, wherein the DC input of the inverter is configured to be connected to a photovoltaic power generator.

13. The inverter according to claim 9, wherein a maximum DC input voltage of the buck converter is by at least 10% higher than a maximum voltage rating of bridge switching elements of the DC/AC converter.

14. The inverter according to claim 13, wherein the maximum DC voltage of the buck converter is approximately 1500 V and a maximum voltage rating of bridge switching elements of the DC/AC converter is approximately 1200 V.

15. The inverter of claim 9, wherein in each subcircuit its inductor, its capacitor and its freewheeling diode are connected together in a closed loop.

16. The inverter of claim 9, wherein the inductors of the subcircuits comprise magnetically coupled chokes.

17. The inverter of claim 9, wherein the inductors of the subcircuits are capacitively coupled at their input ends.

18. The inverter of claim 17, further comprising a coupling capacitor connected between a junction point of the semiconductor switch and the inductor of the first one of the subcircuits and a junction point of the inductor and the freewheeling diode of the second one of the subcircuits.

19. The inverter of claim 18, wherein the coupling capacitor has a capacitance substantially equal to the capacitance of the capacitor of the second one of the subcircuits.

20. The inverter of claim 17, wherein the inductors of the subcircuits comprise magnetically uncoupled inductors comprising air coils.
